(19) United States
(12) Patent Application Publication
(10) Pub. No.: US 2010/0314346 A1
(43) Pub. Date: Dec. 16, 2010

(54) REAR YARD CRANE FOR AUTOMATIC TERMINAL

(76) Inventor: Hong TIAN, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/569,056

(22) Filed: Sep. 29, 2009

(30) Foreign Application Priority Data
Jun. 11, 2009 (CN) 200910052897.1

(51) Int. Cl. B66C 11/08

(52) U.S. Cl. 212/317

(57) ABSTRACT

Embodiments of the present disclosure disclose a rear yard crane for an automatic terminal. The rear yard crane includes a support, a first carrier rail and a first carrier, a second carrier rail and a second carrier, a rotation mechanism and a hoisting mechanism. The support includes a beam positioned along a second orientation and posts supporting the beam. The beam extends to cover ground carrier rails and truck operation areas of the automatic terminal. The second carrier rail is positioned on the beam and the second carrier moves along the second carrier rail. The first carrier rail is positioned along a first orientation being perpendicular to the second orientation on the second carrier and the first carrier moves along the first carrier rail. The rotation mechanism is assembled on the first carrier and is able to rotate at least 90°. The hoisting mechanism is assembled on the rotation mechanism and rotates with the rotation mechanism. The hoisting mechanism includes a spreader for hoisting containers.

### FIELD OF THE INVENTION

The present disclosure relates to container loading/unloading techniques of a container terminal, more particularly, relates to a rear yard crane for an automatic terminal.

### BACKGROUND

With the blooming demand of container transportation and continuous growth of throughput of the container terminals, higher requirements are raised for the container loading/unloading equipments and the container loading/unloading techniques. New container loading/unloading equipments and systems are required to meet the requirements on working efficiency of a scale and speedy automatic terminal.

Generally, a container terminal may be divided into a front area (a quayside area) and a rear area (a yard area) and a middle area. Quayside cranes located in the front area load/unload containers with a container ship, a yard at the rear area is used to stack containers. Trucks are used to transport containers between the front area and the rear area.

For transportation between the quayside cranes and the yard, nowadays, plane trucks driven by diesel engine are used to achieve transportation between a front area and a rear area. For an unloading process, the quayside cranes unload containers from a ship to the plane trucks, the plane trucks transport the containers to a yard, then yard cranes hoist the containers from the plane trucks and put them on the yard. For a loading process, the yard cranes hoist containers from the yard and put them on plane trucks, the plane trucks transport the containers to a position below, the quayside cranes, the quayside cranes load the containers to the ship. Attempts are made for an automatic loading/unloading process for containers, for example, Port of Rotterdam in Netherlands and Hamburger Harbor in Deutschland introduce Automatic Guided Vehicles (AVG) to replace the plane trucks driven by drivers. AGVs are still driven by diesel engine, there is no improvement in energy source. Additionally, AGVs are very expensive, and must move along a single guide line which is buried in advance in a same plane. If one of the AGVs is failed, the whole system is stopped. Unfortunately, failure possibility of AGVs is very high because of the complex structure, failures of AGVs are also difficult to deal with. Therefore, the current attempts of automatic systems face a low efficiency and a high cost.

Whatever the traditional manual manner, or the automatic attempts, the loading/unloading mode of containers can be concluded as: a plane transportation mode consists of quayside cranes located at a quayside area of a container terminal, yard cranes located at a yard area of the container terminal, and diesel engine driven vehicles, such as container trucks, cross transportation trucks, AGVs moving between the quayside cranes and the yard cranes for transporting the containers. The loading/unloading mode needs dozens or even hundreds of diesel engine driven vehicles, for ensuring a smooth movement of these vehicles, a large space must be reserved between the quayside and the yard, which occupies a considerable size of ground. Even a large space is provided, the traffic within the container terminal is still very crowd because all of the vehicles move in a same plane. The vehicles work in a low efficiency, not being able to timely transport containers, and decrease the loading/unloading efficiency of the whole container terminal. Efficiency of vehicles becomes a bottle-neck of loading/unloading efficiency of the container terminal. Furthermore, oil is expensive, operation cost of the container terminal is high and benefit of the container terminal is getting lower. Another problem is, burning oil produces a large amount of exhaust gas and noise, seriously pollute the environment. Maintenance fee of the diesel engine driven vehicles is also very high. The plane transportation technique falls behind, and can not facilitate infomationization, automation and intelligentization of the container terminal.

CN200610025860.6 provides an arrangement scheme of a container terminal, CN200610025860.6 is incorporated herewith by reference.

CN200610025860.6 provides a loading/unloading system for an automatic container terminal, including a three-dimensional low elevated transfer system located between quayside cranes and yard cranes, and cooperating with a ground transportation carrier system. The low elevated transfer system includes at least one low elevated transfer subsystem, each subsystem includes at least one group of low elevated rails disposed along a first orientation (the first orientation refers to the orientation of the containers on the ship, or the orientation parallel to the shore line of the terminal). Each group of low elevated rails includes a low elevated crane rail and a low elevated flat carrier rail. At least one low elevated crane is disposed on the low elevated crane rail and moves along the low elevated crane rail, at least one low elevated flat carrier is disposed on the low elevated flat carrier rail and moves along the low elevated flat carrier rail. The low elevated rails are configured to enable the low elevated flat carriers and the low elevated cranes to reach at least a position where the low elevated cranes can cooperate with trolleys of the quayside cranes and a position where the low elevated cranes can cooperate with the ground transportation carriers. The low elevated cranes may load/unload containers on/off a low elevated flat carrier and a corresponding ground transportation carrier ay any necessary place. The low elevated place carriers may move to a certain position associated with a certain quayside crane and a certain position associated with a certain ground transportation carrier. The ground transportation carrier system includes at least a group of transportation carrier rails disposed along a second orientation (the second orientation refers to the orientation of the containers on the yard, or the orientation perpendicular to the shore line of the terminal), which align to passages in the yard and extend to a necessary position in the yard. The transportation carrier rails also extend to a position below the lowest tier of the low elevated transfer subsystem in the low elevated transfer system. The ground transportation carrier system further includes ground transportation carriers moving along the ground transportation carrier rails. The ground transportation carrier rails are configured to enable the ground transportation carriers to reach at least a position where the ground transportation carriers can cooperate with the low elevated cranes and a position where the ground transportation carriers can cooperate with the yard cranes. The ground transportation carrier rails are further configured to ensure that the ground transportation carriers are not in the same plane with any low elevated flat carriers on any tier of the low elevated transfer system. One of ground transportation carrier or the low elevated crane has an ability to rotate to an angle between the first orientation and the second orientation with or without a container. The ground transportation carrier rails may be configured to extend to an end of the yard rather than entering into the yard, or be configured to extend into a deep position in the yard or extend though the yard.

In a loading process, a yard crane hoists a container in the second direction from a yard, the yard crane moves to a position above a ground transportation carrier along a yard crane rail or the ground transportation carrier moves to a position below the yard crane along a ground transportation carrier rail, the yard crane puts the container onto the ground transportation carrier and the ground transportation carrier moves along the ground transportation carrier rail to a position below a low elevated rail of the low elevated transfer system, the round transportation carrier or a low elevated crane rotates the container from the second direction to the first direction, the low elevated crane hoists the container from the ground transportation carrier to a low elevated flat carrier, the low elevated flat carrier moves along the low elevated flat carrier rail to a position below a quayside crane, the quayside crane hoists the container from the low elevated flat carrier to the ship. In a unloading process, a quayside crane hoists a container in the first direction from a ship and puts the container onto a low elevated flat carrier, the low elevate flat carrier moves along a low elevated flat carrier rail to a position that can cooperate with a ground transportation carrier, a low elevated crane hoists the container to a ground transportation carrier, the low elevated crane or the ground transportation carrier rotates the container from the first direction to the second direction, the ground transportation carrier moves along a ground transportation carrier rail to a yard, a yard crane hoists the container from the ground transportation carrier to the yard.

The invention provided by CN200610025860.6 effectively solves the problem of transportation of containers between the ship and the yard. However, with respect to a whole loading/unloading process for an automatic terminal, one aspect shall further be improved. Since containers need to be loaded/unloaded at the yard by trucks, the transportation between the yard and the trucks is another important factor. To realize a speedy and effective transportation between the yard and the trucks is a significant aspect for improving an automatic terminal scheme. The present disclosure provides a hoisting apparatus for efficient transportation between the yard and the trucks, and adapted to the automatic terminal.

### SUMMARY

Embodiments of the present disclosure provide a crane, well-adapted to an automatic container terminal, to realize efficient container transportation between a yard and trucks.

According to an embodiment of the present disclosure, a rear yard crane for an automatic terminal is provided. The rear yard crane comprises a support, a first carrier rail, a first carrier, a second carrier rail, a second carrier, a rotation mechanism and a hoisting mechanism.

The support comprises a beam positioned along a second orientation and posts supporting the beam. The beam extends to cover ground carrier rails and truck operation areas of the automatic terminal. The second carrier rail is positioned on the beam. The second carrier moves along the second carrier rail. The first carrier rail is positioned along a first orientation on the second carrier and the first orientation is perpendicular to the second orientation. The first carrier moves along the first carrier rail. The rotation mechanism is assembled on the first carrier and is able to rotate at least 90°. The hoisting mechanism is assembled on the rotation mechanism and rotates with the rotation mechanism. The hoisting mechanism includes a spreader for hoisting containers.

According to an embodiment, the rotation mechanism includes an annular rail and a circular rotation plate which rotates on the annular rail.

According to an embodiment, the first carrier rail extends to cover the width of at least one group of the ground carrier rails.

According to an embodiment, containers are positioned along the second orientation on the yard, and trucks park along the first orientation beneath the support.

According to an embodiment, the rotation mechanism rotates 90°, together with the hoisting mechanism and containers hoisted by the hoisting mechanism, during a movement from the ground carriers rails to the truck operation areas, or vise versa.

According to an embodiment, the support comprises two groups of posts, wherein a first group of posts are connected with a first end of the beam, the first end facing a landside of the terminal; a second group of posts are connected with an area on the beam between a second end and a middle point of the beam, the second end facing a seaside of the terminal.

According to an embodiment, the second group of posts includes inclined supporting poles. The inclined supporting poles extends from the second group of posts to an area between a joint of the beam and the second group of posts and the second end of the beam.

The rear yard crane provided by embodiments of the present disclosure is well-adapted to an automatic terminal and realizes efficient transportation of containers with trucks. The rear yard crane further contributes to an improved automatic terminal, and enhances the working efficiency of an automatic terminal.

### BRIEF DESCRIPTION OF THE DRAWING(S)

The above or other features, natures or advantages of the present invention will be more apparent to the skilled person in the art by the following descriptions of the embodiments accompanying with the drawings, the same sign reference indicates the identical features throughout the description, and wherein:

FIG. 1 is a top view of a rear yard crane according to an embodiment of the present disclosure;

FIG. 2 is a side view of the embodiment shown in FIG. 1; and

FIG. 3 is a front view of the embodiment shown in FIG. 1.

### DETAILED DESCRIPTION

As mentioned above, the rear yard crane cooperates with the automatic terminal disclosed in CN200610025860.6. For the purpose of clarity, a first orientation and a second orientation are defined as follows in the description here below:

The first orientation is defined as the orientation of the containers on the ship, or the orientation parallel to the shore line.

The second orientation is defined as the orientation of the containers on the yard, or the orientation perpendicular to the shore line.

The first orientation and the second orientation are defined as the same orientations as that of CN200610025860.

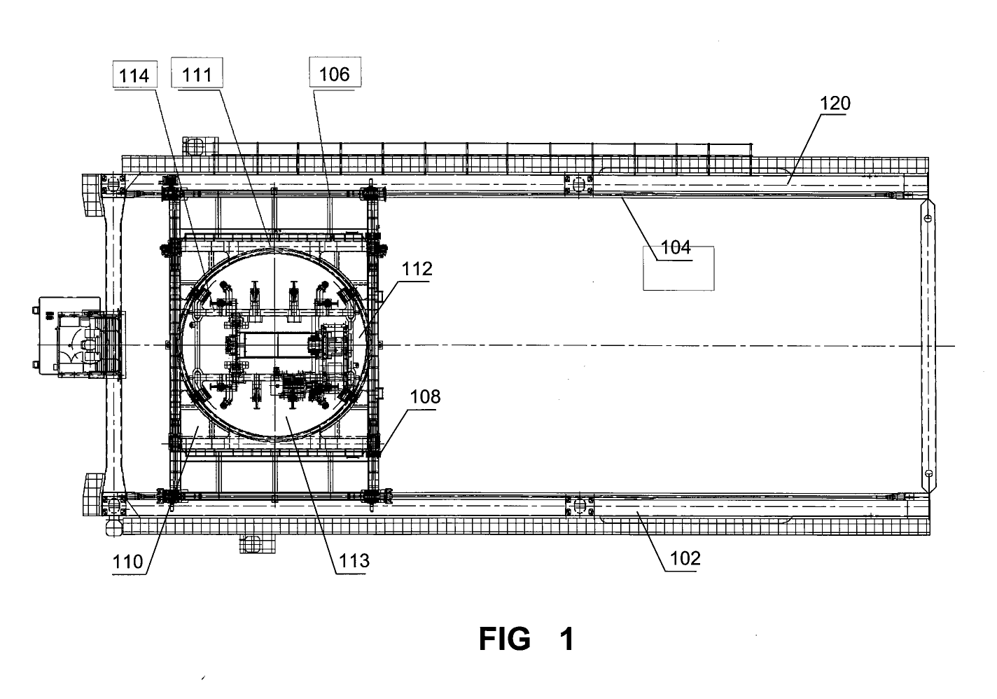

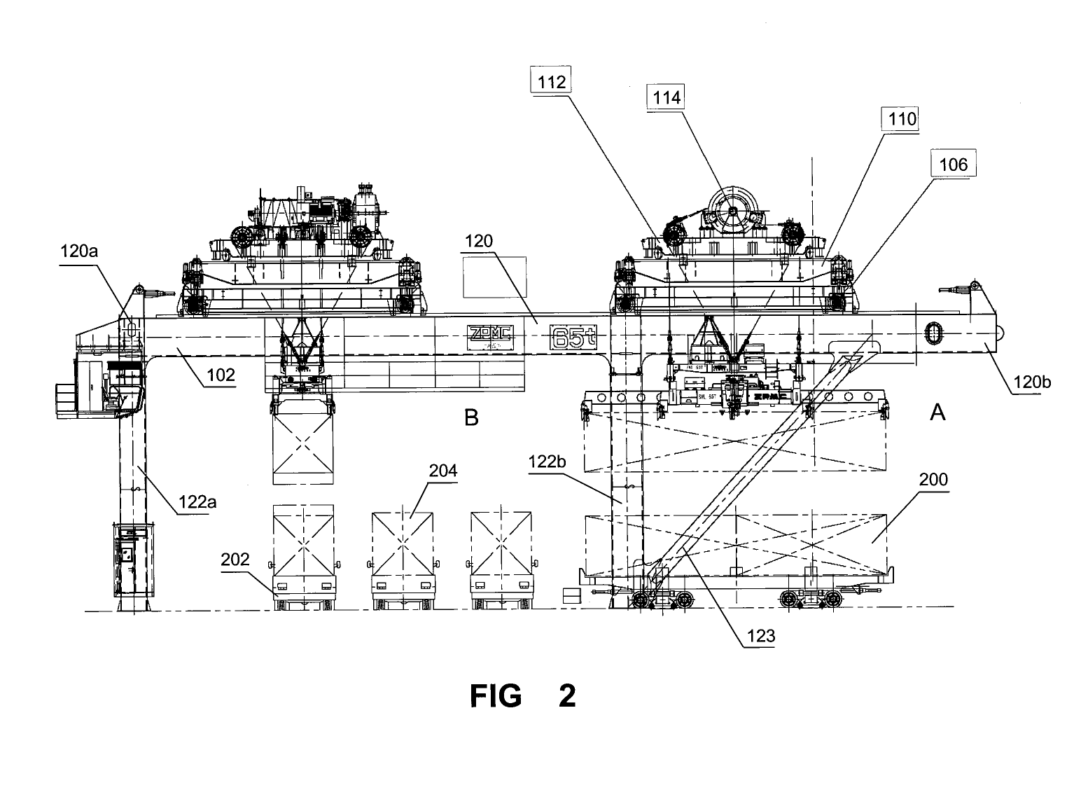

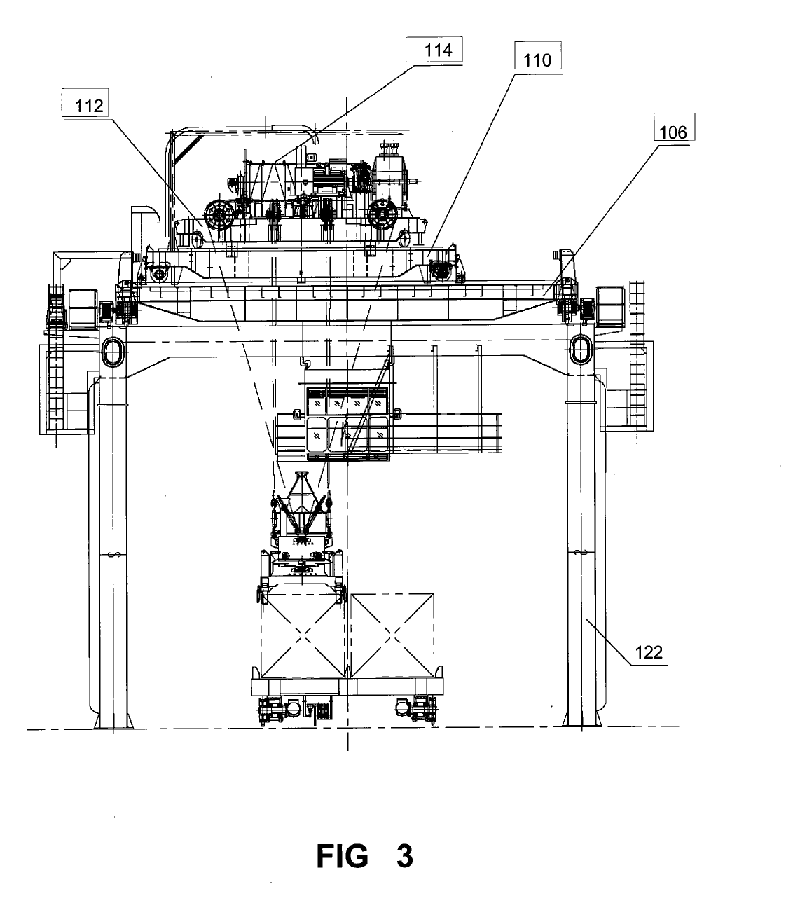

As shown in FIGS. 1 to 3, FIGS. 1 to 3 disclose a rear yard crane according to an embodiment of the present disclosure. FIG. 1 is a top view, FIG. 2 is a side view and FIG. 3 is a front view.

The rear yard crane includes a support 102 composed of a beam 120 and posts 122, a first carrier rail 108 and a first carrier 110 moving thereon, a second carrier rail 104 and a second carrier 106 moving thereon, a rotation mechanism 112 assembled on the first carrier 110, and a hoisting mechanism 114 assembled on the rotation mechanism 112.

The support 102 includes a beam 120 positioned along a second orientation and posts 122 supporting the beam 120. The beam 120 extends to cover ground carrier rails A and truck operation areas B of the automatic terminal. According to the embodiment shown in FIGS. 1-3, the support 102 includes two posts 122. A first group of posts 122a are connected to a first end 120a of the beam 120. The first end 120a faces a landside of the terminal. A second group of posts 122b are connected to an area on the beam between a second end 120b and a middle point of the beam 120. The second end 120b faces a seaside of the terminal. As shown in FIG. 1, truck operation areas B are placed between the first group of posts 122a and the second group of posts 122b. The ground carrier rails A are placed in an area extended from the second group of posts 122b towards the second end 120b of the beam 120. It is to be noted that the joints of the two groups of posts and the beams are not fixed. Generally speaking, the first group of posts 122a are set near the first end 120a so as to obtain a larger truck operation area. The position of the second group of posts 122b are relatively flexible. It is only required that the second group of posts 122b are set between a second end 120b and a middle point of the beam 120. According to the embodiment shown in FIG. 1, the second group of posts 122b are set near the middle point of the beam 120. The second group of posts 120 further include inclined supporting poles 123 which extends from the second group of posts 122b to an area between a joint of the beam and the second group of posts and the second end of the beam.

For realizing a fast movement between the yard and a position over the trucks, the rear yard crane disclosed in the present disclosure uses two stacked carriers. A second carrier 106 moves along a second carrier rail 104 is positioned on the beam 120. Generally, the second carrier rail 104 extends through substantially the whole length of the beam so that the second carrier 106 may easily reach any position between the two ends of the beam 120. The second carrier 106 realizes a longitudinal movement. A first carrier 110 is stacked on the second carrier 106. The first carrier 110 moves along a first carrier rail 108. The orientation of the first carrier rail 108 is perpendicular to the orientation of the second carrier rail 104. The first carrier 108 realizes a movement along the width of the crane. As shown in FIG. 3, the first carrier rail 108 extends through the whole length of the second carrier 106. With the cooperation of the first carrier 110 and the second carrier 106, the rotation mechanism, the hoisting mechanism and the container on the first carrier may reach any position in the area covered by the crane.

As shown in FIG. 2, the containers on the yard of the automatic terminal are deployed along the second orientation, and the container 200 put on the ground carrier is also deployed along the second orientation. The trucks park along the first orientation beneath the support, and the container 204 on the truck 202 is also deployed along the first orientation.

The rotation mechanism 112 and the hoisting mechanism 114 are used to realize the change of orientation of the containers. The rotation mechanism 112 is assembled on the first carrier 110, and the rotation mechanism 112 is able to rotate at least 90°. The rotation mechanism 112 includes an annular rail 111 and a circular rotation plate 113. According to an embodiment, the rotation plate 113 is able to rotate 360° on the annular rail 111. The hoisting mechanism 114 is assembled on the rotation mechanism 112 and rotates together with the rotation mechanism 112. The hoisting mechanism 114 includes a spreader for hoisting containers. The wires of the hoisting mechanism 114 may go through the gaps in the rotation plate 113 and extend to a position beneath the rotation plate 113. The wires are connected to a head block. The spreader and the container is connected to the lower side of the head block. The hoisting mechanism performs a lifting/unlifting operation to implement the lifting/unlifting of the container. According to an embodiment, the hoisting mechanism 114 is assembled on the rotation plate 113. When the rotation plate 113 rotates, the hoisting mechanism rotates together with the rotation plate 113. The head block, the spreader and the container also rotate with the hoisting mechanism through the wires. The design of the head block and the spreader are well known techniques in the art and will not be described in detail here. The rotation mechanism 112 shall be able to rotate at least 90° because the difference between the first orientation and the second orientation is 90°. According to an embodiment, the rotation mechanism 112 may rotate any degree clockwise or counter-clockwise. The rotation may be implemented when both the first carrier and the second carrier are in a stationary state. Or the rotation may be implemented during a movement by the first carrier and the second carrier from the ground carrier rails to the truck operation areas, or vice versa.

An operation process of the rear yard crane is as follows:

A process of transportation from a truck to the yard: the truck parks in the first orientation on the truck operation area B beneath the beam. The first carrier and the second carrier move to a position above the truck, the hoisting mechanism and the spreader hoist the container in the first orientation from the truck. The first carrier and the second carrier move to a position above the ground carrier. During the movement of the first carrier and the second carrier, the rotation mechanism rotates, together with the hoisting mechanism and the container, 90° from the first orientation to the second orientation. The hoisting mechanism and the spreader put the container to the ground carrier. The following procedure may refer to the description in CN200610025860.6, the ground carrier and the yard crane will transfer the container to the yard.

A process of transportation from the yard to a truck is as follows: the first carrier and the second carrier move to a position above the ground carrier. The hoisting mechanism and the spreader hoist the container in the second orientation from the ground carrier. The first carrier and the second carrier move to a position above the truck parking in the first orientation on the truck operation area B beneath the beam. During the movement of the first carrier and the second carrier, the rotation mechanism rotates, together with the hoisting mechanism and the container, 90° from the second orientation to the first orientation. The hoisting mechanism and the spreader put the container to the truck.

The rear yard crane provided by embodiments of the present disclosure is well-adapted to an automatic terminal and realizes an efficient transportation of containers with trucks. The rear yard crane further contributes to an improved automatic terminal, and enhances the working efficiency of the automatic terminal.

1. A rear yard crane for an automatic terminal, comprising:
a support, comprising a beam positioned along a second orientation and posts supporting the beam, the beam extending to cover ground carrier rails and truck operation areas of the automatic terminal;
a second carrier rail positioned on the beam;
a second carrier moving along the second carrier rail;
a first carrier rail positioned along a first orientation on the second carrier, the first orientation being perpendicular to the second orientation;
a first carrier, moving along the first carrier rail;
a rotation mechanism, assembled on the first carrier and being able to rotate at least 90°;
a hoisting mechanism, assembled on the rotation mechanism and rotating with the rotation mechanism, the hoisting mechanism comprising a spreader for hoisting containers.

2. The rear yard crane of claim 1, wherein the rotation mechanism comprises:
an annular rail and a circular rotation plate, the rotation plate rotating on the annular rail.

3. The rear yard crane of claim 1, wherein the first carrier rail extends to cover the width of at least one group of ground carrier rails.

4. The rear yard crane of claim 1, wherein containers are positioned along the second orientation on the yard, and trucks park along the first orientation beneath the support.

5. The rear yard crane of claim 1, wherein the rotation mechanism rotates 90°, together with the hoisting mechanism and containers hoisted by the hoisting mechanism, during a movement from the ground carriers rails to the truck operation areas, or vise versa.

6. The rear yard crane of claim 1, wherein the support comprises two groups of posts,
wherein a first group of posts are connected to a first end of the beam, the first end facing a landside of the terminal;
a second group of posts are connected to an area on the beam between a second end and a middle point of the beam, the second end facing a seaside of the terminal.

7. The rear yard crane of claim 1, wherein the second group of posts comprise inclined supporting poles, the inclined supporting poles extending from the second group of posts to an area between a joint of the beam and the second group of posts and the second end of the beam.
